(19) United States
(12) Patent Application Publication
(10) Pub. No.: US 2022/0155746 A1
(43) Pub. Date: May 19, 2022

(54) PROGRAM CREATION SUPPORT DEVICE, PROGRAM CREATION SUPPORT METHOD, AND STORAGE MEDIUM

(71) Applicant: Mitsubishi Electric Corporation, Tokyo (JP)

(72) Inventors: Masahira IKEDA, Tokyo (JP); Ryota HASHIMOTO, Tokyo (JP)

(73) Assignee: Mitsubishi Electric Corporation, Tokyo (JP)

(21) Appl. No.: 17/434,012

(22) PCT Filed: Apr. 16, 2019
(86) PCT No.: PCT/JP2019/016329

§ 371 Date: Aug. 26, 2021

(51) Int. Cl. G05B 19/05

(52) U.S. Cl. CPC G05B 19/056; G05B 2219/13004

(57) ABSTRACT

A program creation support device including a control unit internally having a first memory and controlling the programmable logic controller having a refresh function and a network unit internally having a second memory and acquiring data from a device to be controlled and storing the data in the second memory. The support device includes: a program extraction unit extracting a description indicating access to the second memory from a pre-conversion sequence program before being converted into a format understandable by the programmable logic controller; a storage unit storing memory allocation setting information indicating a relationship between a specific region of the first memory and a specific region of the second memory; and a program replacement unit replacing a description indicating access to the second memory in the pre-conversion sequence program with a description indicating access to the first memory based on the memory allocation setting information.

### FIELD

The present invention relates to a program creation support device, a program creation support method, and a program that support creation of a program to be executed in a programmable logic controller (hereinafter referred to as PLC).

### BACKGROUND

In the factory automation (FA) field, an automatic control device using a PLC has been conventionally used. The PLC generally includes a central processing unit (CPU) unit and a network unit for communication that operates in cooperation with the CPU unit. In the PLC, a communication network is constructed using the network unit, and communication between the CPU unit and a sensor at a remote location or the like is realized using the communication network.

In addition, it is also possible to construct a system including a plurality of networks for one CPU unit by attaching a plurality of network units on a base unit on which the CPU unit is attached.

One network is constructed with a network unit (hereinafter, referred to as a remote station) installed at a remote location to collect a value of a sensor at the remote location and a network unit (hereinafter, referred to as a master station) attached on the base unit to communicate with the remote station. The remote station and the master station each include a memory (hereinafter, referred to as a network-side memory). A device such as a sensor can be connected to the remote station, and the remote station collects measurement values such as sensor values from the connected device and stores the measurement values in its own network-side memory. The master station receives the measurement value collected by each of the remote stations at a determined timing and stores the measurement value in its own network-side memory, thereby aggregating the measurement values collected by the remote stations. The CPU unit can read measurement values outputted from devices connected to the remote stations by acquiring the measurement values stored in the network-side memory of the master station.

Here, a time required for a CPU constituting the CPU unit to acquire data stored in the network-side memory of the master station is longer than a time required for the CPU constituting the CPU unit to acquire data stored in a memory (hereinafter, referred to as a CPU-side memory) in the CPU unit. This is because inter-unit communication via the base unit occurs when the CPU of the CPU unit acquires a value in the network-side memory. Even if a configuration employed here is not a configuration in which the CPU unit and the network unit (master station) are attached on the base unit and communicate with each other via the base unit, but a configuration in which the CPU unit and the master station can directly communicate with each other, the time required for the CPU constituting the CPU unit to acquire the data stored in the network-side memory of the master station is longer.

Therefore, in general, the PLC has a function of synchronizing the data stored in a designated region of the CPU-side memory with the data stored in a designated region of the network-side memory. This function is also referred to as a refresh function. In the refresh function, a process of duplicating the data stored in the designated region of the CPU-side memory and transferring the resultant data to the designated region of the network-side memory is repeatedly executed with a predetermined period. As a result, the data stored in the designated region of the network-side memory is updated to the same data as the data stored in the designated region of the network-side memory with the predetermined period (see, for example, Patent Literature 1).

In the invention described in Patent Literature 1, speed-up of the processing is realized with the number of times of data transfer occurring at the time of execution of the refresh function being reduced.

### CITATION LIST

### Patent Literature

Patent Literature 1: Japanese Patent Application Laid-open No. 2003-29809

### SUMMARY

### Technical Problem

In order to use the refresh function, it is necessary to perform memory allocation work, that is, a work by which association is made about a value of which region of the CPU-side memory should be synchronized with a value of which region of the network-side memory. In addition, a worker who creates a program to be executed by the PLC needs to perform programming with a state of the memory allocation in mind. That is, the worker needs to perform her or his programming with taking into account the following points: a point that a value outputted from which device connected to the remote station should be stored in which region of the network-side memory; and another point that a value in which region of the network-side memory should be synchronized with a value in which region of the CPU-side memory. Therefore, there has been a problem that a work load of a program creator increases.

The present invention has been made in view of the above circumstances, and an object thereof is to provide a program creation support device capable of reducing a work load of a worker who creates a program to be executed by a PLC.

### Solution to Problem

In order to solve the above-mentioned problems and achieve the object, the present invention provides a program creation support device that supports creation of a sequence program to be executed by a programmable logic controller including a control unit and a network unit, the control unit having a first memory thin inside thereof and controlling an operation of the programmable logic controller as a whole, the network unit having a second memory in inside thereof and acquiring data from a device to be controlled by the programmable logic controller to store the data in the second memory, the programmable logic controller having a refresh function of synchronizing a value of a specific region of the first memory with a value of a specific region of the second memory, the program creation support device comprising: a program extraction unit to extract a description indicating access to the second memory from a pre-conversion sequence program that is a sequence program before being converted into a format understandable by the programmable logic controller; a storage unit to store memory allocation setting information indicating a correspondence relationship between the specific region of the first memory and the specific region of the second memory; and a program replacement unit to replace a description indicating access to the second memory in the pre-conversion sequence program with a description indicating access to the first memory on the basis of the memory allocation setting information stored in the storage unit.

### Advantageous Effects of Invention

A program creation support device according to the present invention achieves an advantageous effect that it is possible to reduce a work load of a worker who creates a program to be executed by a PLC.

### BRIEF DESCRIPTION OF DRAWINGS

FIG. 1 is a diagram illustrating an example of a PLC using a program created by a program creation support device according to the present invention.

FIG. 2 is a diagram illustrating an example configuration of the program creation support device according to a first embodiment.

FIG. 3 is a diagram illustrating an example configuration of hardware by which the program creation support device according to the first embodiment can be implemented.

FIG. 4 is a flowchart illustrating an example of an operation of the program creation support device according to the first embodiment.

FIG. 5 is a diagram illustrating an example of a program block included in a CPU program created by the program creation support device according to the first embodiment.

FIG. 6 is a diagram illustrating an example of memory allocation setting information created by the program creation support device according to the first embodiment.

FIG. 7 is a diagram illustrating an example of a program block included in the CPU program created by the program creation support device according to the first embodiment.

FIG. 8 is a diagram illustrating an example configuration of a program creation support device according to a second embodiment.

FIG. 9 is a flowchart illustrating an example of an operation of the program creation support device according to the second embodiment.

FIG. 10 is a diagram illustrating an example of the memory allocation setting information created by the program creation support device according to the second embodiment.

FIG. 11 is a diagram illustrating an example of a program block included in the CPU program created by the program creation support device according to the second embodiment.

### DESCRIPTION OF EMBODIMENTS

Hereinafter, a program creation support device, a program creation support method, and a program according to embodiments of the present invention will be described in detail with reference to the drawings. The present invention is not necessarily limited by these embodiments.

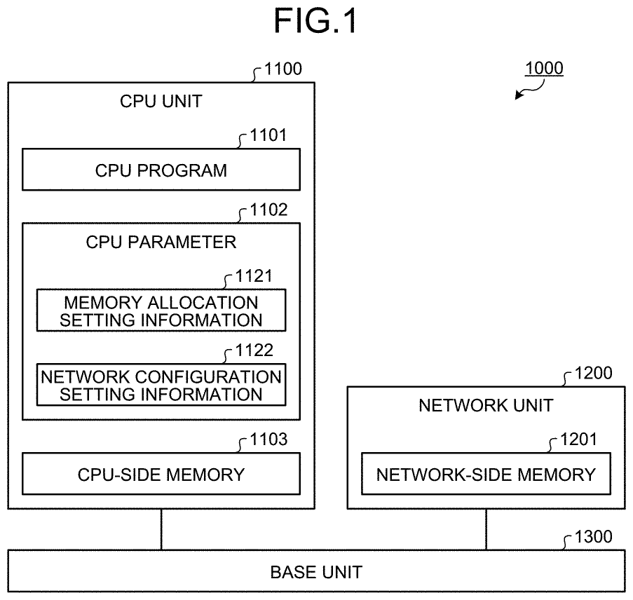

First, a PLC using a program created by a program creation support device according to the present invention will be described with reference to FIG. 1. FIG. 1 is a diagram illustrating an example of the PLC using a program created by the program creation support device according to the present invention.

A PLC 1000 illustrated in FIG. 1 includes a CPU unit 1100 that is a control unit configured to control an operation of the PLC 1000 as a whole, a network unit 1200 that forms a communication network, and a base unit 1300 to which the CPU unit 1100 and the network unit 1200 are connected. The CPU unit 1100 and the network unit 1200 are each attached on a predetermined attachment position on the base unit 1300. In addition to the CPU unit 1100 and the network unit 1200, an input unit, an output unit, and the like are attached on the base unit 1300 depending on the intended application, but descriptions of units other than the CPU unit 1100 and the network unit 1200 will be omitted in description here. The network unit 1200 is connected to other network units (not illustrated in FIG. 1) via a communication line. A device to be controlled by the PLC 1000 is connected to the other network unit. The PLC 1000 has a refresh function and can synchronize data stored in a designated region of the CPU-side memory with data stored in a designated region of the network-side memory.

The CPU unit 1100 stores a CPU program 1101 that is a sequence program described in a ladder language or the like, and operates in accordance with program codes described in the CPU program 1101 to realize a control operation of the PLC 1000 as a whole. Furthermore, the CPU unit 1100 includes a CPU parameter 1102 for setting an operation of a CPU (not illustrated), and a CPU-side memory 1103 in which a result of an arithmetic operation performed in accordance with the CPU program 1101, and the like are stored. The CPU parameter 1102 includes memory allocation setting information 1121 that is information used in the refresh function, and network configuration setting information 1122 that indicates devices on the communication network managed by the network unit 1200 attached on the base unit 1300 and a region of the network-side memory 1201 that can be referred to by the CPU unit 1100. The memory allocation setting information 1121 indicates to which region of a memory (network-side memory 1201, described later) in the network unit 1200 each of regions where data is updated by the refresh function, among the regions of the CPU-side memory 1103 is allocated. The CPU-side memory 1103 is a first memory of the PLC 1000.

The network unit 1200 serves as a master station and includes the network-side memory 1201. Information acquired from a device such as a sensor in the communication network by a remote station that is the other network unit described above is aggregated in the network-side memory 1201. The network-side memory 1201 is a second memory of the PLC 1000.

Hereinafter, embodiments of a program creation support device according to the present invention will be described on the assumption that the CPU program 1101 to be executed by the CPU unit 1100 of the PLC 1000 illustrated in FIG. 1 is created.

### First Embodiment

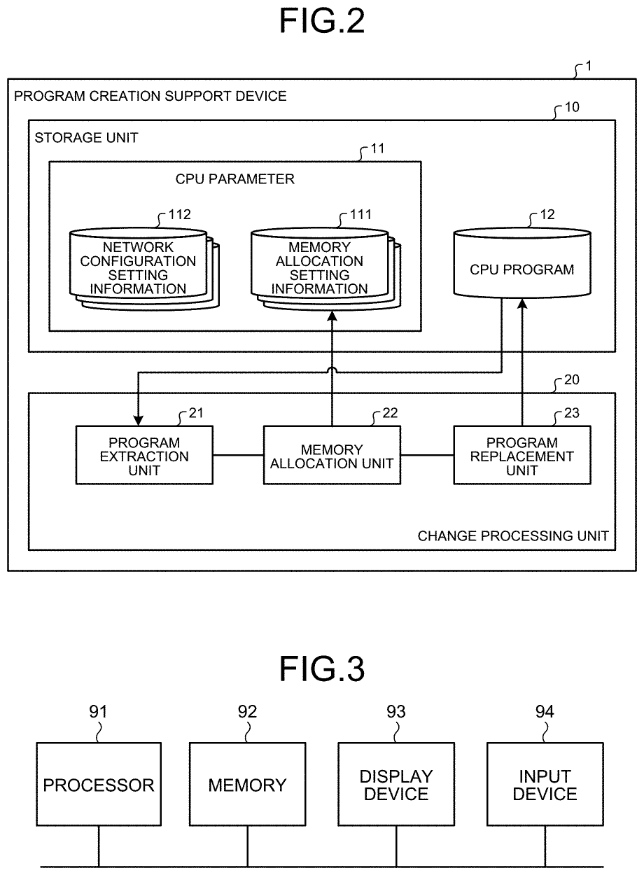

FIG. 2 is a diagram illustrating an example configuration of a program creation support device according to a first embodiment. A program creation support device 1 according to the first embodiment includes a storage unit 10 that stores a CPU parameter 11 and a CPU program 12, and a change processing unit 20 that changes the CPU program 12. The CPU program 12 is a sequence program similarly to the CPU program 1101 illustrated in FIG. 1, but is a sequence program before being converted into a format that can be understood by the CPU unit 1100 of the PLC 1000.

The program creation support device 1 receives an operation from a worker who performs programming, and creates the CPU parameter 11 and the CPU program 12 in accordance with the content of the operation. The program creation support device 1 automatically creates memory allocation setting information 111 of the CPU parameter 11. The CPU program 12 illustrated in FIG. 2 is based on program codes created by the worker using a ladder language or the like, and is a sequence program similarly to the CPU program 1101 illustrated in FIG. 1. However, the CPU program 12 is in a state before being compiled and converted into a format that can be understood by the CPU of the CPU unit 1100. The CPU program 12 is a pre-conversion sequence program. The CPU program 12 is compiled to be converted into the format that can be understood by the CPU of the CPU unit 1100, and then transferred to the CPU unit 1100 of the PLC 1000 illustrated in FIG. 1 via a communication line or the like. The CPU unit 1100 stores a program received from the program creation support device 1 as the CPU program 1101. Note that, in FIG. 2, descriptions of a means for realizing a process of receiving the operation from the worker and creating the CPU program 12, a means for transferring an after-conversion program obtained by compiling the CPU program 12 to the CPU unit 1100, and the like are omitted. These means are similar to a program creation means, a compiling means, a program transfer means, and the like included in a general program creation device used for a programming work of a sequence program for a PLC. A program creation means for creating the CPU program 12 may exist outside the program creation support device 1. That is, the program creation support device 1 may be configured to receive, from another device, a CPU program without being compiled, which is created by the other device.

In the following description, it is assumed that the program creation support device 1 stores the CPU program 12 that has been completely created. It is also assumed that the CPU program 12 includes an instruction to access the network-side memory 1201.

The CPU parameter 11 corresponds to the CPU parameter 1102 stored in the CPU unit 1100 of the PLC 1000 illustrated in FIG. 1. The memory allocation setting information 111 corresponds to the memory allocation setting information 1121 stored in the CPU unit 1100, and network configuration setting information 112 corresponds to the network configuration setting information 1122 stored in the CPU unit 1100. The memory allocation setting information 111 and the network configuration setting information 112 are created for each communication network. For example, in a case where three remote stations are connected to the network unit 1200 of the PLC 1000, the memory allocation setting information 111 and the network configuration setting information 112 are created for each of the three remote stations. The CPU parameter 11 is transferred to the CPU unit 1100 together with an after-conversion program obtained by compiling the CPU program 12.

The change processing unit 20 includes a program extraction unit 21, a memory allocation unit 22, and a program replacement unit 23.

The program extraction unit 21 analyzes the CPU program 12 and extracts a part where a content representing access to the network-side memory 1201 is described, from the CPU program 12.

The memory allocation unit 22 updates the memory allocation setting information 111 on the basis of the content of the description in the part extracted by the program extraction unit 21. The update operation of the memory allocation setting information 111 also includes a process of newly creating the memory allocation setting information 111 when the memory allocation setting information 111 to be updated does not exist.

The program replacement unit 23 replaces the CPU program 12 on the basis of the memory allocation setting information 111 updated by the memory allocation unit 22. Specifically, the program replacement unit 23 rewrites a description that is included in the CPU program 12 and indicates access to the network-side memory 1201, as a description indicating access to the CPU-side memory 1103. For example, a case is assumed where the memory allocation setting information 111 includes information indicating that a region of address Al of the CPU-side memory 1103 is associated with a region of address B1 of the network-side memory 1201. In that case, the program replacement unit 23 rewrites a description that is included in the CPU program 12 and indicates access to the region of address B1 of the network-side memory 1201, as a description indicating access to the region of address A1 of the CPU-side memory 1103.

Here, hardware for implementing the program creation support device 1 having the configuration illustrated in FIG. 2 will be described. FIG. 3 is a diagram illustrating an example configuration of hardware capable of realizing the program creation support device 1 according to the first embodiment. The hardware illustrated in FIG. 3 is, for example, a personal computer, which is equipped with a processor 91, a memory 92, a display device 93, and an input device 94. The processor 91 is a CPU, which is also referred to as a central processing device, a processing device, an arithmetic device, a microprocessor, a microcomputer, or a digital signal processor (DSP). The memory 92 is a non-volatile or volatile semiconductor memory such as a random access memory (RAM), a read only memory (ROM), a flash memory, an erasable programmable read only memory (EPROM), or an electrically erasable programmable read only memory (EEPROM (registered trademark)); a magnetic disk; an optical disc; a compact disc; a mini disk; a digital versatile disc (DVD); or the like. The display device 93 is a liquid crystal monitor, a display module, or the like. The input device 94 is a keyboard, a mouse, or the like.

The storage unit 10 of the program creation support device 1 is realized by the memory 92. The change processing unit 20 of the program creation support device 1 is realized by the processor 91 and the memory 92. That is, the program extraction unit 21, the memory allocation unit 22, and the program replacement unit 23 of the change processing unit 20 are implemented by the memory 92 storing therein programs for realizing the functions of these units and the processor 91 reading the programs from the memory 92 and executing the programs.

The programs for realizing the units of the change processing unit 20 may be provided to a user in a state of being stored in the memory 92 in advance, or may be provided to the user in a state of being written in a computer-readable recording medium such as a CD-ROM (compact disc ROM) or a DVD-ROM (digital versatile disc ROM) to be installed in the memory 92 by the user. Furthermore, the programs may be provided to the user via a communication line such as the internet.

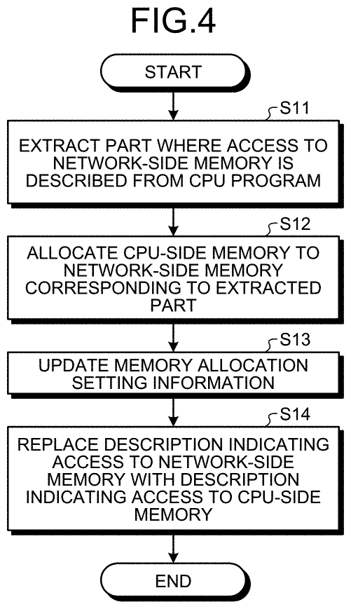

FIG. 4 is a flowchart illustrating an example of an operation of the program creation support device 1 according to the first embodiment, specifically, a flowchart illustrating an example of an operation of the change processing unit 20. When receiving a predetermined operation from the user who is a creator of the CPU program 12, the change processing unit 20 starts the operation illustrated in FIG. 4. The predetermined operation corresponds to an operation of instructing creation of the memory allocation setting information 111, an operation of instructing execution of compilation of the CPU program 12, and the like. In a case where the operation illustrated in FIG. 4 is started in response to receiving the operation of instructing execution of compilation of the CPU program 12, the program creation support device 1 executes the compilation after the operation illustrated in FIG. 4 ends.

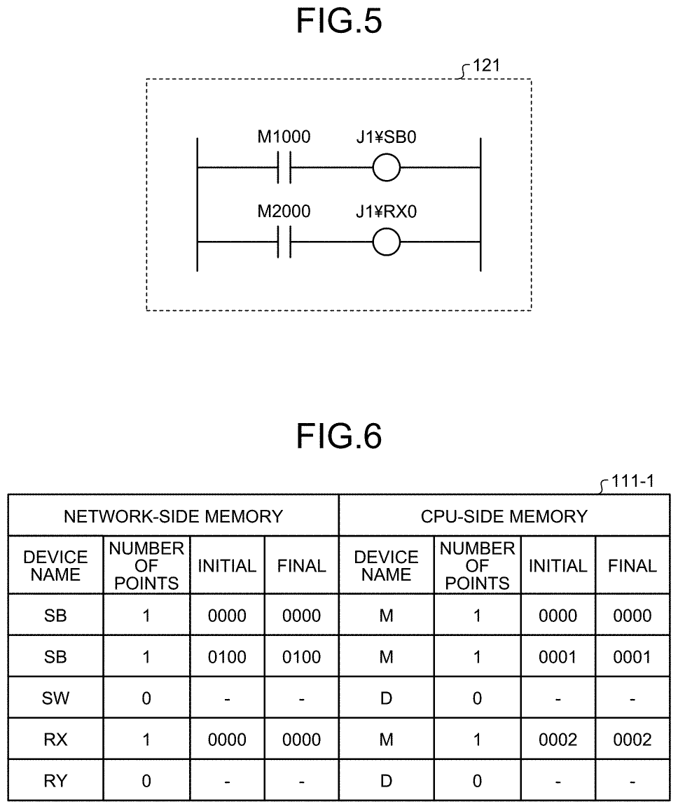

When starting the operation, the change processing unit 20 extracts a part where access to the network-side memory 1201 is described from the CPU program 12 (step S11). Specifically, the program extraction unit 21 reads the CPU program 12 from the storage unit 10 and analyzes the CPU program 12, and extracts a description indicating access to the network-side memory 1201. For example, it is assumed that a program block 121 illustrated in FIG. 5 is included in the CPU program 12. FIG. 5 is a diagram illustrating an example of a program block included in the CPU program 12 created by the program creation support device 1 according to the first embodiment. In the program block 121, descriptions of “J1¥SB0” and “J1¥RX0” indicate a memory (network-side memory 1201) inside a network unit that manages a network having a network identifier of “J1”. Therefore, the program extraction unit 21 extracts the descriptions of “J1¥SB0” and “J1¥RX0”. “SB0” and “RX0” following “J1¥” indicate specific regions of the network-side memory 1201. Note that “SB” and “RX” indicate types of values stored in the regions, and are also called device names. In addition, the size of data stored in a region to which each device name is assigned is predetermined. Similarly, in the CPU-side memory 1103, a specific region of the CPU-side memory 1103 is indicated by a combination of a device name and a numerical value. The program extraction unit 21 extracts a description indicating access to the network-side memory 1201 from a part other than the program block 121 of the CPU program 12 by a similar manner.

Next, the change processing unit 20 allocates the CPU-side memory 1103 to the network-side memory 1201 corresponding to the part extracted in step S11 (step S12). Specifically, the memory allocation unit 22 allocates regions of the CPU-side memory 1103 to respective regions of the network-side memory 1201 indicated by descriptions extracted by the program extraction unit 21. Hereinafter, this process is referred to as a “memory allocation process”. In the memory allocation process, the memory allocation unit 22 allocates a region of the CPU-side memory 1103 while memorizing information about which region of the CPU-side memory 1103 has been allocated to the network-side memory 1201 so as not to redundantly allocate the same region of the CPU-side memory 1103 to different regions of the network-side memory 1201. It is assumed that a region (range) of the CPU-side memory 1103 that can be allocated to the network-side memory 1201 is designated in advance by the user or designated in advance by a manufacturer. In step S12, the memory allocation unit 22 selects a region that has not been subjected to allocation yet, from the designated range of the CPU-side memory 1103 and performs allocation of the selected one.

Next, the change processing unit 20 updates the memory allocation setting information 111 (step S13). Specifically, the memory allocation unit 22 reflects a result of the memory allocation process of step S12 in the memory allocation setting information 111. Here, in a case where a plurality of communication networks are constructed for one CPU unit 1100, there are pieces of the memory allocation setting information 111 the number of which is as many as the number of networks to be constructed. Therefore, the memory allocation unit 22 updates the memory allocation setting information 111 of a communication network corresponding to the description indicating access to the network-side memory 1201. In a case where the memory allocation setting information 111 of the communication network corresponding to the description indicating access to the network-side memory 1201 does not exist in the storage unit 10, the memory allocation unit 22 newly creates the memory allocation setting information 111. The memory allocation setting information 111 can be, for example, information having a formation illustrated in FIG. 6. FIG. 6 is a diagram illustrating an example of the memory allocation setting information 111 created by the program creation support device 1 according to the first embodiment. In FIG. 6, the “number of points” indicates the size of each region, and when the number of points is “1”, it means one bit. “Initial” represents an initial address of each region, and “final” represents a final address of each region. FIG. 6 illustrates an example of a case where the CPU program 12 has three descriptions indicating access to the network-side memory 1201, two of which are descriptions each indicating access to a region of which a device name is SB, and the remaining one of which is a description indicating access to a region of which a device name is RX. Memory allocation setting information 111-1 illustrated in FIG. 6 represents that a region of the CPU-side memory 1103 with a device name “M” and an address “0000 to 0000” is allocated to a region of the network-side memory 1201 with a device name “SB” and an address “0000 to 0000”, that a region of the CPU-side memory 1103 with device name “M” and address “0001 to 0001” is allocated to a region of the network-side memory 1201 with a device name “SB” and an address “0100 to 0100”, and that a 1-bit region of the CPU-side memory 1103 with a device name “M” and an address “0002 to 0002” is allocated to a region of the network-side memory 1201 with a device name “RX” and an address “0000 to 0000”. The hyphens (-) written in “initial” and “final” of the device names “SW” and “RY” mean that because descriptions indicating access to regions with the device names “SW” and “RY” are not included in the CPU program 12, these descriptions have not been extracted in step S11 described above.

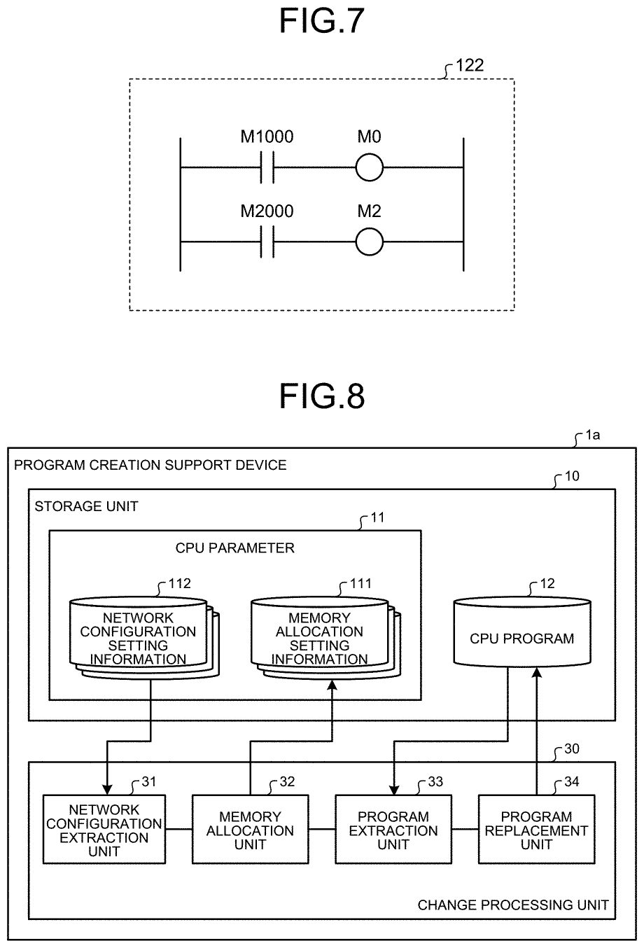

Next, the change processing unit 20 replaces the description indicating access to the network-side memory 1201 in the CPU program 12 with a description indicating access to the CPU-side memory 1103 (step S14). Specifically, the program replacement unit 23 changes the description indicating access to the network-side memory 1201 in the CPU program 12 to the description indicating access to a region of the CPU-side memory 1103 associated with the region indicated by the above description on the basis of the memory allocation setting information 111 updated by the memory allocation unit 22. When the program replacement unit 23 performs a replacement process on the basis of the memory allocation setting information 111-1 illustrated in FIG. 6, the program block 121 illustrated in FIG. 5 is converted into a program block 122 illustrated in FIG. 7. FIG. 7 is a diagram illustrating an example of a program block included in the CPU program 12 created by the program creation support device 1 according to the first embodiment. As illustrated in FIGS. 5 to 7, when the program replacement unit 23 executes the replacement process of step S14, the descriptions of “J1¥SB0” and “J1¥RX0” that are included in the program block 121 and indicate access to the network-side memory 1201 are rewritten as descriptions of “M0” and “M2” indicating access to the CPU-side memory 1103, respectively, and the program block 122 illustrated in FIG. 7 is obtained. The program replacement unit 23 similarly replaces a description indicating access to the network-side memory 1201 with a description indicating access to the CPU-side memory 1103 also for parts other than the program block 121 in the CPU program 12.

As described above, the program creation support device 1 according to the present embodiment extracts a description indicating access to the network-side memory 1201 from the CPU program 12, allocates an unused region of the CPU-side memory 1103 to a region indicated by the extracted description to generate or update the memory allocation setting information 111 indicating to which region of the network-side memory 1201 each of regions where data is updated by the refresh function is allocated. Furthermore, the program creation support device 1 replaces the description indicating access to the network-side memory 1201 in the CPU program 12 with the description indicating access to the CPU-side memory 1103 on the basis of the memory allocation setting information 111. As a result, the user who is the worker who creates the CPU program 12 does not need to perform the work of creating and updating the memory allocation setting information 111, and thus her or his work load of creating the program is reduced. In addition, the user no longer needs to perform programming with the content of the memory allocation setting information 111 in mind.

### Second Embodiment

FIG. 8 is a diagram illustrating an example configuration of a program creation support device according to a second embodiment. A program creation support device 1a according to the second embodiment has a configuration obtained by replacing the change processing unit 20 of the program creation support device 1 described in the first embodiment with a change processing unit 30. In the present embodiment, differences from the first embodiment will be described.

The change processing unit 30 of the program creation support device 1a includes a network configuration extraction unit 31, a memory allocation unit 32, a program extraction unit 33, and a program replacement unit 34. The program extraction unit 33 and the program replacement unit 34 perform processes similar to those performed by the program extraction unit 21 and the program replacement unit 23 of the program creation support device 1 according to the first embodiment, respectively. Similarly to the program creation support device 1 according to the first embodiment, the program creation support device 1a can be implemented by the hardware illustrated in FIG. 3.

The network configuration extraction unit 31 is an information acquisition unit. The network configuration extraction unit 31 extracts information on a designated region of the network-side memory 1201 that can be referred to by the CPU unit 1100 from the network configuration setting information 112. The said designated region is a region in which a duplicate of stored data can be transferred to the network-side memory 1201 by the refresh function. The information on the designated region of the network-side memory 1201 that can be referred to by the CPU unit 1100 is set as information having a configuration that indicates which region of the network-side memory 1201 can be used as a storage region with which device name.

The memory allocation unit 32 updates the memory allocation setting information 111 similarly to the memory allocation unit 22 of the program creation support device 1 according to the first embodiment, but the content of a process to be executed in the update operation is partially different therebetween. The memory allocation unit 32 updates the memory allocation setting information 111 on the basis of the information extracted by the network configuration extraction unit 31.

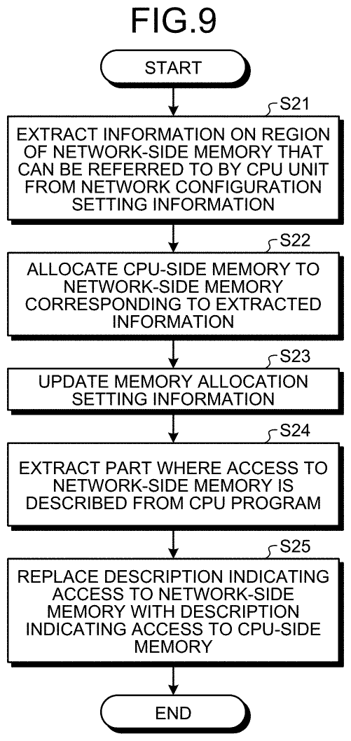

FIG. 9 is a flowchart illustrating an example of an operation of the program creation support device la according to the second embodiment, specifically, a flowchart illustrating an example of an operation of the change processing unit 30. Similarly to the change processing unit 20 of the program creation support device 1, when receiving a predetermined operation from a user who is a creator of the CPU program 12, the change processing unit 30 starts the operation illustrated in FIG. 9.

When starting the operation, the change processing unit 30 extracts information on a region of the network-side memory 1201 that can be referred to by the CPU unit 1100 from the network configuration setting information 112 (step S21). The process of step S21 is performed by the network configuration extraction unit 31. The region of the network-side memory 1201 that can be referred to by the CPU unit 1100 corresponds to the above-described designated region. The region of the network-side memory 1201 that can be referred to by the CPU unit 1100 is a region ensured as a region for storing data such as a measurement value required by the CPU unit 1100 when the network unit 1200 acquires the data. The region of the network-side memory 1201 that can be referred to by the CPU unit 1100 is set by the user before starting programming of the CPU program 12, or during the programming.

Next, the change processing unit 30 allocates the CPU-side memory 1103 to the network-side memory 1201 corresponding to the information extracted in step S21 (step S22). Specifically, the memory allocation unit 32 performs a memory allocation process of allocating a region of the CPU-side memory 1103 to a region of the network-side memory 1201 indicated by the information extracted by the network configuration extraction unit 31. It is assumed that the region of the CPU-side memory 1103 that can be allocated to the network-side memory 1201 is designated in advance by the user or designated in advance by a manufacturer. In step S22, the memory allocation unit 32 selects an unallocated region from the designated range of the CPU-side memory 1103 and performs allocation accordingly.

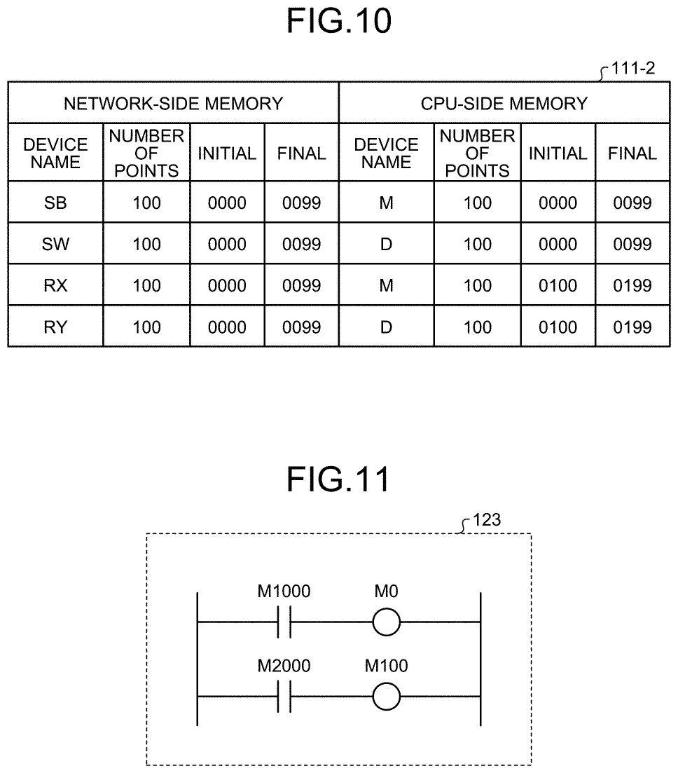

Next, the change processing unit 30 updates the memory allocation setting information 111 (step S23). Specifically, the memory allocation unit 32 reflects a result of the memory allocation process of step S22 in the memory allocation setting information 111. FIG. 10 is a diagram illustrating an example of the memory allocation setting information 111 created by the program creation support device 1a according to the second embodiment. As illustrated in memory allocation setting information 111-2 of FIG. 10, the memory allocation unit 32 allocates regions of the CPU-side memory 1103 to regions (four regions in FIG. 10) of the network-side memory 1201 that are ensured for respective device names and can be referred to by the CPU unit 1100. In the memory allocation setting information 111-2, pieces of information in the fields of “device name”, “number of points”, “initial”, and “final” of the “network-side memory” described on the left side are pieces of information extracted from the network configuration setting information 112 by the network configuration extraction unit 31 in step S21 described above. Pieces of information in the fields of “device name”, “number of points”, “initial”, and “final” of the “CPU-side memory” described on the right side are pieces of information allocated by the memory allocation unit 32 in step S22 described above.

Next, the change processing unit 30 extracts a part where access to the network-side memory 1201 is described from the CPU program 12 (step S24). The process of step S24 is similar to the process of step S11 described in the first embodiment, which is performed by the program extraction unit 33.

Next, the change processing unit 30 replaces a description indicating access to the network-side memory 1201 in the CPU program 12 with a description indicating access to the CPU-side memory 1103 (step S25). The process of step S25 is similar to the process of step S14 described in the first embodiment, which is performed by the program replacement unit 34. When the program replacement unit 34 performs a replacement process on the basis of the memory allocation setting information 111-2 illustrated in FIG. 10, the program block 121 illustrated in FIG. 5 is converted into a program block 123 illustrated in FIG. 11. FIG. 11 is a diagram illustrating an example of a program block included in the CPU program 12 created by the program creation support device 1a according to the second embodiment. As illustrated in FIGS. 5, 10, and 11, when the program replacement unit 34 executes the replacement process of step S25, the descriptions of “J1¥SB0” and “J1¥RX0” that are included in the program block 121 and indicate access to the network-side memory 1201 are rewritten as descriptions of “M0” and “M100”, respectively, indicating access to the CPU-side memory 1103, and the program block 123 illustrated in FIG. 11 is obtained. The program replacement unit 34 similarly replaces a description indicating access to the network-side memory 1201 with a description indicating access to the CPU-side memory 1103 also for parts other than the program block 121 in the CPU program 12. For example, in a case where the program extraction unit 33 has extracted a description of “J1¥SW10” in step S24, the program replacement unit 34 rewrites this description as “D10”.

As described above, the program creation support device 1a according to the present embodiment generates or updates the memory allocation setting information 111 on the basis of the information on a region of the network-side memory 1201 that can be referred to by the CPU unit 1100, the information being included in the network configuration setting information 112 of the CPU parameter 11. Furthermore, the program creation support device 1a replaces the description indicating access to the network-side memory 1201 in the CPU program 12 with the description indicating access to the CPU-side memory 1103 on the basis of the memory allocation setting information 111. The program creation support device 1a according to the present embodiment can achieve advantageous effects similar to those of the program creation support device 1 according to the first embodiment.

The configurations described in the embodiments above are merely examples of the content of the present invention, and can each be combined with other publicly known techniques and partially omitted and/or modified without departing from the scope of the present invention.

The description has been given in each embodiment based on the assumption that the PLC 1000 has the configuration illustrated in FIG. 1, that is, the PLC 1000 is configured with various units including the CPU unit 1100 and the network unit 1200 being attached on the base unit 1300, but the base unit 1300 is not essential. The invention described in each embodiment can be applied even to a PLC configured by directly connecting these units.

### REFERENCE SIGNS LIST

1, 1a program creation support device; 10 storage unit; 11, 1102 CPU parameter; 12, 1101 CPU program; 20, 30 change processing unit; 21, 33 program extraction unit; 22, 32 memory allocation unit; 23, 34 program replacement unit; 31 network configuration extraction unit; 111, 111-1, 111-2, 1121 memory allocation setting information; 112, 1122 network configuration setting information; 121, 122, 123 program block; 1000 PLC; 1100 CPU unit; 1103 CPU-side memory; 1200 network unit; 1201 network-side memory; 1300 base unit.

1. A program creation support device that supports creation of a sequence program to be executed by a programmable logic controller including a controller and a network controller, the controller having a first memory and controlling an operation of the programmable logic controller as a whole, the network controller having a second memory and acquiring data from a device to be controlled by the programmable logic controller to store the data in the second memory, the programmable logic controller having a refresh function of synchronizing a value of a specific region of the first memory with a value of a specific region of the second memory, the program creation support device comprising:
program extraction circuitry to extract a description indicating access to the second memory from a pre-conversion sequence program that is a sequence program before being converted into a format understandable by the programmable logic controller;
a memory to store memory allocation setting information indicating a correspondence relationship between the specific region of the first memory and the specific region of the second memory; and
program replacement circuitry to replace a description indicating access to the second memory in the pre-conversion sequence program with a description indicating access to the first memory on the basis of the memory allocation setting information stored in the memory.

2. The program creation support device according to claim 1, wherein:
the memory allocation setting information indicates to which region of the second memory each of regions where a value is updated by the refresh function, among regions of the first memory, is allocated.

3. The program creation support device according to claim 1, further comprising:
memory allocation circuitry to allocate regions of the first memory to respective regions of the second memory indicated by respective descriptions extracted by the program extraction circuitry to generate the memory allocation setting information.

4. The program creation support device according to claim 1, further comprising:
information acquisition circuitry to acquire information on a region that can be referred to by the controller among regions of the second memory; and
memory allocation circuitry to allocate a region of the first memory to a region of the second memory indicated by information acquired by the information acquisition circuitry to generate the memory allocation setting information.

5. The program creation support device according to claim 3, wherein:
the programmable logic controller includes two or more network controllers including the network controller and being equivalent to the network controller, and
the memory allocation circuitry generates memory allocation setting information for each of these network controllers.

6. The program creation support device according to claim 3, wherein:
the specific region of the first memory and the specific region of the second memory are constituted by a plurality of regions, and
the memory allocation circuitry generates the memory allocation setting information such that each of regions constituting the specific region of the first memory is not redundantly allocated to the plurality of regions constituting the specific region of the second memory.

7. The program creation support device according to claim 3, wherein:
the memory allocation circuitry selects the specific region of the first memory from a range designated in advance by a user among regions of the first memory, and associates the specific region of the first memory with the specific region of the second memory.

8. The program creation support device according to claim 3, wherein:
the memory allocation circuitry selects the specific region of the first memory from a range designated in advance by a manufacturer of the programmable logic controller among regions of the first memory, and associates the specific region of the first memory with the specific region of the second memory.

9. A program creation support method that supports creation of a sequence program to be executed by a programmable logic controller including a controller and a network controller, the controller having a first memory and controlling an operation of the programmable logic controller as a whole, the network controller having a second memory and acquiring data from a device to be controlled by the programmable logic controller to store the data in the second memory, the programmable logic controller having a refresh function of synchronizing a value of a specific region of the first memory with a value of a specific region of the second memory, the program creation support method comprising:
extracting a description indicating access to the second memory from a pre-conversion sequence program that is a sequence program before being converted into a format understandable by the programmable logic controller;
storing, in a memory, memory allocation setting information indicating a correspondence relationship between the specific region of the first memory and the specific region of the second memory; and
replacing, a description indicating access to the second memory in the sequence program with a description indicating access to the first memory on the basis of the memory allocation setting information stored in the storage memory.

10. A non-transitory computer readable medium for storing therein a program that supports creation of a sequence program to be executed by a programmable logic controller including a controller and a network controller, the controller having a first memory and controlling an operation of the programmable logic controller as a whole, the network controller having a second memory and acquiring data from a device to be controlled by the programmable logic controller to store the data in the second memory, the programmable logic controller having a refresh function of synchronizing a value of a specific region of the first memory with a value of a specific region of the second memory, the program causing a computer to execute:
extracting a description indicating access to the second memory from a pre-conversion sequence program that is a sequence program before being converted into a format understandable by the programmable logic controller;
storing, in a memory, memory allocation setting information indicating a correspondence relationship between the specific region of the first memory and the specific region of the second memory; and
replacing a description indicating access to the second memory in the sequence program with a description indicating access to the first memory on the basis of the memory allocation setting information stored in the storage unit memory.

11. The program creation support device according to claim 4, wherein:
the programmable logic controller includes two or more network controllers including the network controller and being equivalent to the network controller, and
the memory allocation circuitry generates memory allocation setting information for each of these network controllers.

12. The program creation support device according to claim 4, wherein:
the specific region of the first memory and the specific region of the second memory are constituted by a plurality of regions, and
the memory allocation circuitry generates the memory allocation setting information such that each of regions constituting the specific region of the first memory is not redundantly allocated to the plurality of regions constituting the specific region of the second memory.

13. The program creation support device according to claim 4, wherein
the memory allocation circuitry selects the specific region of the first memory from a range designated in advance by a user among regions of the first memory, and associates the specific region of the first memory with the specific region of the second memory.

14. The program creation support device according to claim 4, wherein
the memory allocation circuitry selects the specific region of the first memory from a range designated in advance by a manufacturer of the programmable logic controller among regions of the first memory, and associates the specific region of the first memory with the specific region of the second memory.
